(19) United States
(12) Patent Application Publication
(10) Pub. No.: US 2018/0084460 A1
(43) Pub. Date: Mar. 22, 2018

(54) SHARING SYSTEM RESOURCES BETWEEN MOBILE DEVICES

(71) Applicant: QUALCOMM Incorporated, San Diego, CA (US)

(72) Inventor: Brendan David TOWNSEND, Cambridge (GB)

(21) Appl. No.: 15/273,203

(22) Filed: Sep. 22, 2016

(51) Int. Cl. H04W 28/16

(52) U.S. Cl. CPC H04W 28/16; H04W 76/023

(57) ABSTRACT

Disclosed are methods and systems for sharing system resources between a first mobile device and a second mobile device. In an aspect, an external interface controller of the first mobile device establishes a connection between the first mobile device and the second mobile device, receives, from the second mobile device, data representing system resources of the second mobile device, and performs a function utilizing the system resources of the first mobile device and the system resources of the second mobile device, wherein performance of the function is facilitated by a data routing and resource control module of the first mobile device exchanging, independently of a processor of the first mobile device, data related to the function with the second mobile device via the external interface controller.

### INTRODUCTION

Embodiments relate to sharing system resources between a first mobile device and a second mobile device.

Portable battery-powered computing holds widespread attraction for both personal and professional users, but due to the performance limitations of conventional battery-powered devices, they continue to give ground to more powerful desktop and laptop systems. This is particularly the case for demanding professional software applications and resource-intensive gaming applications that require significant processing power.

Although it is expected that portable system specifications will continue to improve, it is also expected that professional and gaming software will continue to leverage the additional computing power offered by these increasingly more powerful systems. It is also expected that demanding users will continue to choose to avail themselves of improving technologies and portable convenience where it exists.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an aspect, a method for sharing system resources between a first mobile device and a second mobile device includes establishing, by an external interface controller of the first mobile device, a connection between the first mobile device and the second mobile device, receiving, at the first mobile device from the second mobile device, data representing system resources of the second mobile device; and performing, by the first mobile device, a function utilizing the system resources of the first mobile device and the system resources of the second mobile device, wherein performance of the function is facilitated by a data routing and resource control module of the first mobile device exchanging, independently of a processor of the first mobile device, data related to the function with the second mobile device via the external interface controller.

In an aspect, an apparatus for sharing system resources between a first mobile device and a second mobile device includes at least one processor, an external interface controller configured to: establish a connection between the first mobile device and the second mobile device, and receive, from the second mobile device, data representing system resources of the second mobile device, and a data routing and resource control module configured to facilitate performance of a function that utilizes the system resources of the first mobile device and the system resources of the second mobile device, wherein the data routing and resource control module being configured to facilitate the performance of the function comprises the data routing and resource control module being configured to exchange, independently of the at least one processor, data related to the function with the second mobile device via the external interface controller.

In an aspect, a non-transitory computer-readable medium for sharing system resources between a first mobile device and a second mobile device includes at least one instruction to cause an external interface controller of the first mobile device to establish a connection between the first mobile device and the second mobile device, at least one instruction to cause the first mobile device to receive, from the second mobile device, data representing system resources of the second mobile device, and at least one instruction to cause the first mobile device to perform a function utilizing the system resources of the first mobile device and the system resources of the second mobile device, wherein performance of the function is facilitated by a data routing and resource control module of the first mobile device exchanging, independently of a processor of the first mobile device, data related to the function with the second mobile device via the external interface controller.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of embodiments of the disclosure will be readily obtained as the same becomes better understood by reference to the following detailed description when considered in connection with the accompanying drawings which are presented solely for illustration and not limitation of the disclosure, and in which:

FIG. 1A is an illustration of screen sharing among two mobile devices.

FIG. 1B is another illustration of screen sharing among the two mobile devices.

FIG. 2A is an illustration of a shared-resource system among two mobile devices according to at least one aspect of the disclosure.

FIG. 2B is another illustration of a shared-resource system among two mobile devices according to at least one aspect of the disclosure.

FIG. 3 illustrates an exemplary high-level system architecture of a mobile device according to at least one aspect of the disclosure.

FIG. 4 illustrates an exemplary high-level system architecture of a mobile device according to at least one aspect of the disclosure

FIG. 5 illustrates an exemplary flow for sharing system resources between a first mobile device and a second mobile device according to at least one aspect of the disclosure.

FIG. 6 is a simplified block diagram of several sample aspects of an apparatus configured to support operations as taught herein.

### DETAILED DESCRIPTION

Disclosed are methods and systems for sharing system resources between a first mobile device and a second mobile device. In an aspect, an external interface controller of the first mobile device establishes a connection between the first mobile device and the second mobile device, receives, from the second mobile device, data representing system resources of the second mobile device, and performs a function utilizing the system resources of the first mobile device and the system resources of the second mobile device, wherein performance of the function is facilitated by a data routing and resource control module of the first mobile device exchanging, independently of a processor of the first mobile device, data related to the function with the second mobile device via the external interface controller.

These and other aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Professional office software (e.g., computer-aided design (CAD) software) and simultaneously-running applications often benefit from a larger screen area and improved system resources in order to afford enhanced productivity on-the-move. High-end gaming applications often benefit from larger or additional screens and improved system resources in order to provide smoother game-play with improved peripheral vision for added competitive advantage and a more immersive experience. Such gaming applications can also benefit from distributed speakers for an even more immersive gaming experience.

However, a single mobile device (e.g., a tablet computer) directly serving multiple screens places a significant additional load on the processing resources associated with the driving (master) machine, and causes a corresponding battery drain. While it is currently possible to add screens using additional mobile devices (e.g., additional tablet computers), screen-sharing software, and conventional interconnects (e.g., Universal Serial Bus (USB), High-Definition Multimedia Interface (HDMI), WiFi, Bluetooth®, etc.), doing so adds latency and places further resource demands on the driving machine. This also results in unleveraged resources on the additional machines that are simply displaying served graphics.

There are various factors to consider when addressing these issues. For example, mobile devices must continue to offer an attractive cost-to-performance ratio to maintain their wide market appeal, which limits the addition of costly technologies and associated special interfaces to every product. Battery power demand and service life also remain a significant concern for self-contained mobile devices.

As another example, gaming applications place a particular strain on the processing resources of the mobile device, such as higher processing power, high-definition graphics capabilities, and speed of performance for minimal latency. A single (master) mobile device serving multiple screens for such demanding gaming applications would ultimately result in additional system load on the serving mobile device, reduced screen refresh rates, and cause stuttered performance, thereby imposing limits on the additional number (if any) of screens that may be acceptably driven.

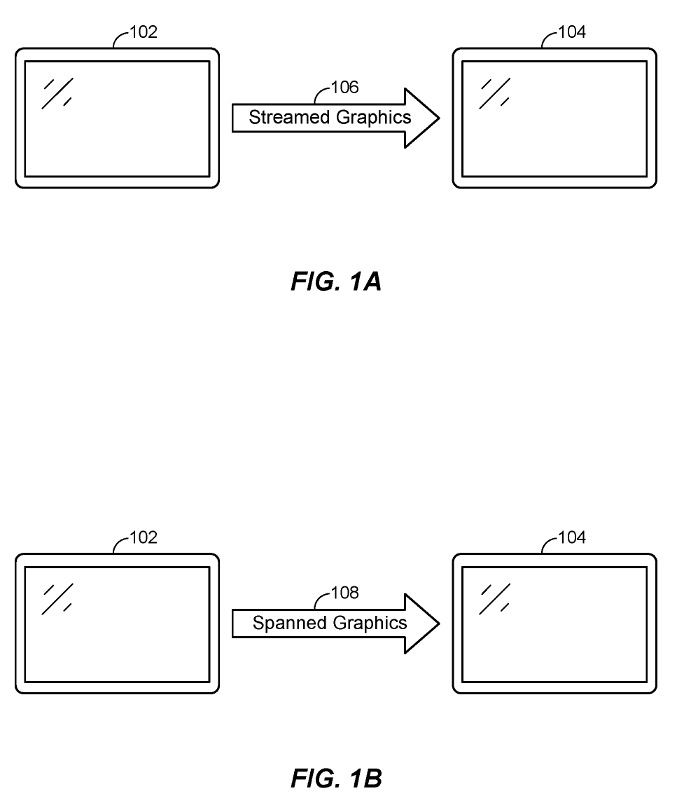

FIG. 1A is an illustration of screen sharing among two mobile devices 102 and 104. As an example, mobile devices 102 and 104 may be tablet computers. In the example of FIG. 1A, a software application running on mobile device 102, such as a gaming application, serves the screens of both mobile devices 102 and 104 to provide enhanced gameplay. Where the software application is a gaming application, mobile device 102 transmits streamed graphics 106 associated with the gaming application to mobile device 104.

Typically, mobile device 104 primarily serves to transfer the streamed graphics 106 to its screen, but does nothing to contribute to software processes performed by mobile device 102, with the corresponding limitations on system load and scalability. The streaming of high-definition graphics demands relatively high-bandwidth through the communications layer.

FIG. 1B is another illustration of screen sharing among the two mobile devices 102 and 104. In the example of FIG. 1B, a software application running on mobile device 102, such as a CAD application, serves the screens of both mobile devices 102 and 104 to provide an improved work area. Where the software application is a CAD application, mobile device 102 transmits spanned graphics 108 associated with the CAD application to mobile device 104.

As in the example of FIG. 1A, mobile device 104 primarily serves to transfer the spanned graphics 108 to its screen, but does nothing to contribute to software processes performed by mobile device 102, with the corresponding limitations on system load and scalability. Further, demands on the processing power and runtime RAM of mobile device 102 may limit or obstruct applications that mobile device 102 could otherwise run.

The proposed system incorporates a flexible communications layer within a mobile device in order to provide efficient internal resource-sharing between mobile devices, thereby facilitating load-balancing of available resources among the mobile devices. The net result can provide seamless scalable expansion of the combined system resources, alleviating the demands otherwise placed on a single system serving both runtime processes and additional screens.

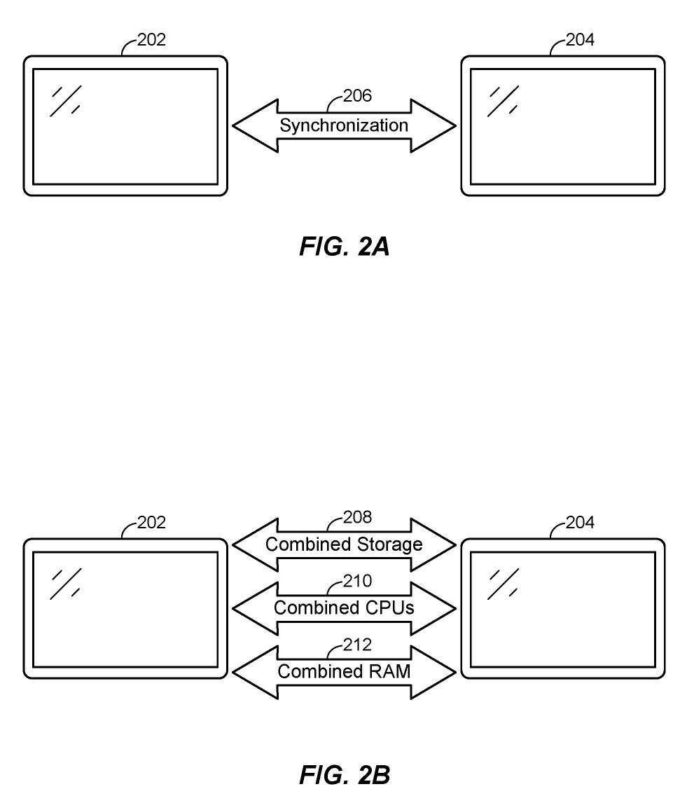

FIG. 2A is an illustration of a shared-resource system among two mobile devices 202 and 204 according to at least one aspect of the disclosure. As an example, mobile devices 202 and 204 may be tablet computers. The mobile devices 202 and 204 may be connected to each other over a wired or wireless connection (e.g., USB, HDMI, WiFi, LTE-Direct, Bluetooth®, etc.).

In an embodiment, both mobile devices 202 and 204 may have the same software application, such as a game application, installed. Each instance of the application may serve a separate viewing/audio perspective for the software application. For example, the separate viewing perspectives may be “first-person” and “third-person” perspectives of the user's character in the game, a “first-person” perspective and a map view, etc. The separate audio perspectives may be “surround-sound” perspectives, such as sounds coming from the left and right sides of the user's character in the game. In the shared resource system of the present disclosure, and as will be described further herein, synchronization data 206 is exchanged between mobile devices 202 and 204 in order to synchronize the separate viewing perspectives of the software application. Each mobile device otherwise executes the software application using its own resources.

In another embodiment, however, only mobile device 202 may have the software application installed. In this embodiment, as will be described further herein, the mobile device 202 may transmit data needed to execute the software application on the mobile device 202 to the mobile device 204. Alternatively, the mobile device 202 may only transmit the data needed to provide the separate viewing/audio perspectives of the software application on the mobile device 204. The mobile device 202 may also transmit synchronization data 206 to the mobile device 204 to synchronize the separate viewing/audio perspectives of the software application.

FIG. 2B is another illustration of a shared-resource system among the two mobile devices 202 and 204 according to at least one aspect of the disclosure. For example, a user may wish to utilize the mobile devices 202 and 204 as a dual-screen work station. As such, in the example of FIG. 2B, the mobile devices 202 and 204 may share one or more resources, such as combined storage 208, combined CPUs 210, combined RAM 212, and/or the like. More specifically, processing power and runtime RAM on mobile device 202 may be supported by the processor and available RAM on mobile device 204, in addition to offering an expanded work area (via screen sharing). Modern high-speed interfaces, such as USB3 and/or HDMI, and the potential for the same application to be installed on both machines (further enabling distributed CPU threading), renders such an approach practicable.

Additionally, as described below, the combined storage between mobile devices 202 and 204 offers further security potential by way of “striping” sensitive data between systems, such that the theft or loss of either associated system would render data recovery impossible.

Although FIGS. 2A and 2B illustrate only two mobile devices, the proposed system is highly scalable, and there may be any number of connected mobile devices. Additional mobile devices may be added and synchronised for additional viewing/audio perspectives, offering significant scalability due to distributed load-balancing and reduced bandwidth requirements of the synchronisation among the mobile devices.

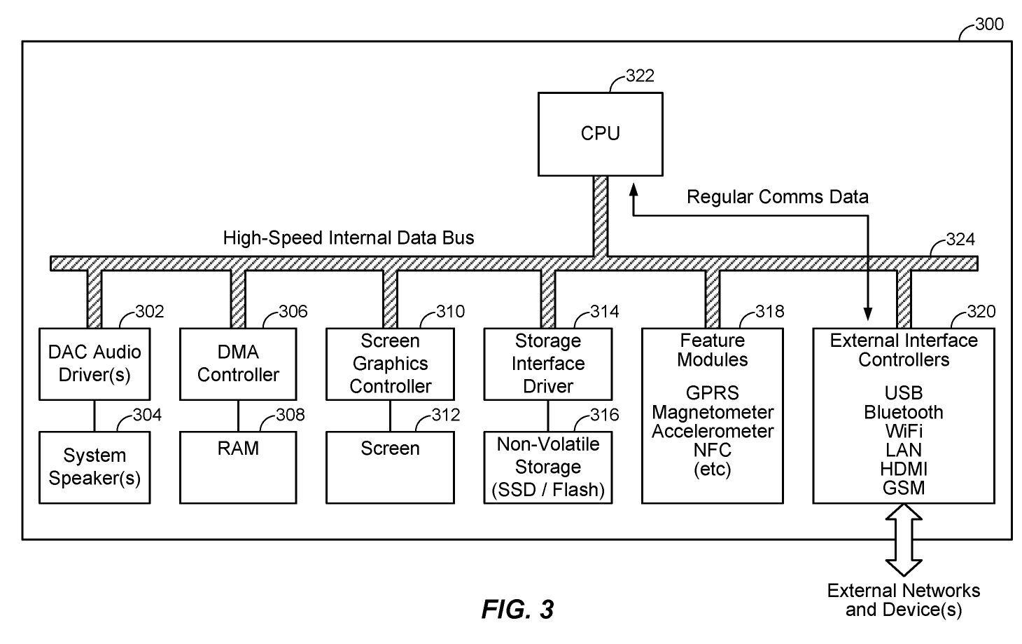

FIG. 3 illustrates an exemplary high-level system architecture of a mobile device 300, such as a tablet computer, according to at least one aspect of the disclosure. The mobile device 300 includes a CPU 322 connected via a high-speed/high-bandwidth data bus 324 to one or more digital-to-analog converter (DAC) audio drivers 302, a direct memory access (DMA) controller 306, a screen graphics controller 310, a storage interface driver 314, one or more feature modules 318, and one or more external interface controllers 320. The DAC audio driver(s) 302 is/are coupled to one or more system speakers 304, the DMA controller 306 is coupled to RAM 308, the screen graphics controller 310 is coupled to the screen 312 (e.g., a touchscreen) of the mobile device 300, and the storage interface driver 314 is coupled to the non-volatile storage 316 (e.g., a solid-state drive (SSD), flash memory, etc.) of the mobile device 300.

The one or more feature modules 318 may include a general packet radio service (GPRS) module, a magnetometer, an accelerometer, a near-field communication (NFC) module, and/or the like. The one or more external interface controllers 320 may include controllers for various external interfaces, such as USB, HDMI, Bluetooth®, WiFi, wired and/or wireless local area network (LAN), Global System for Mobile Communications (GSM), Long-Term Evolution (LTE), and/or the like. These external interfaces enable the mobile device 300 to connect (wired or wirelessly) to one or more other (external) devices.

Any communications between the mobile device 300 and one or more external devices must go through the CPU 322 and over the data bus 324. Thus, incoming communications (e.g., related to the resource sharing described herein) are received by the external interface controllers 320, sent over the data bus 324, and received and processed by the CPU 322. Similarly, outgoing communications are processed by the CPU 322 and sent over the data bus 324 to the external interface controllers 320 where they are transmitted to the external device(s). For example, for the mobile device 300 to display data from an external device on the screen 312, the screen data is received at an external interface controller 320, passed over the data bus 324 to the CPU 322, sent by the CPU 322 to the screen graphics controller 310 over the data bus 324, and displayed on the screen 312. As another example, for the mobile device 300 to send data stored in the non-volatile storage 316 to an external device, the CPU 322 retrieves the data from non-volatile storage 316 via the storage interface driver 314 over the data bus 324, and sends the retrieved data to the appropriate external interface controller 320 over the data bus 324, where it is transmitted to the external device.

As will be appreciated, because all data shared between the mobile device 300 and an external device (or multiple external devices) must pass through the CPU 322 and over the data bus 324, the CPU 322 and the data bus 324 create a bottleneck that can reduce the speed at which data can be shared between the mobile device 300 and one or more external devices. As such, in order to implement the resource sharing between multiple devices described herein, a faster mechanism for exchanging data between the mobile device 300 and external devices would be beneficial.

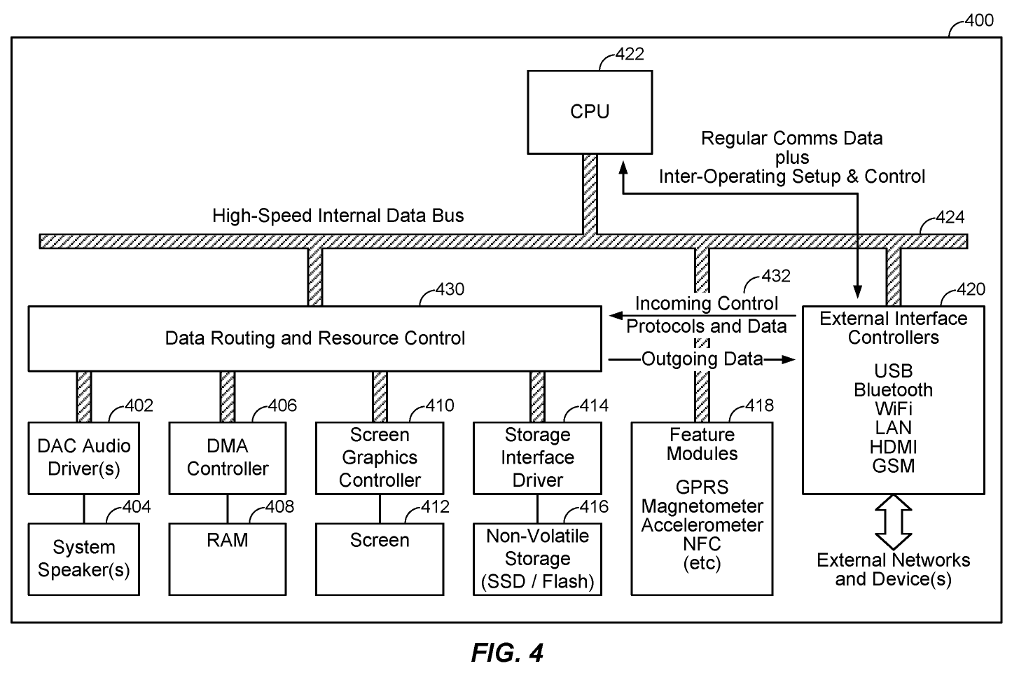

FIG. 4 illustrates an exemplary high-level system architecture of a mobile device 400, such as a tablet computer, according to at least one aspect of the disclosure. Similar to the mobile device 300, the mobile device 400 includes a CPU 422, a high-speed/high-bandwidth data bus 424, one or more digital-to-analog converter (DAC) audio drivers 402, a DMA controller 406, a screen graphics driver 410, a storage interface driver 414, one or more feature modules 418, and one or more external interface controllers 420. The DAC audio driver(s) 402 is/are coupled to one or more system speakers 404, the DMA controller 406 is coupled to RAM 408, the screen graphics driver 410 is coupled to the screen 412 (e.g., a touchscreen) of the mobile device 400, and the storage interface driver 414 is coupled to the non-volatile storage 416 (e.g., a solid-state drive (SSD), flash memory, etc.) of the mobile device 400.

The one or more feature modules 418 may include a GPRS module, a magnetometer, an accelerometer, an NFC module, and/or the like. The external interface controllers 420 may include controllers for various external interfaces, such as USB, HDMI, Bluetooth®, WiFi, wired or wireless LAN, GSM, LTE, and/or the like. These external interfaces enable the mobile device 400 to connect (wired or wirelessly) to one or more other (external) devices.

Unlike the mobile device 300, however, the mobile device 400 also includes a data routing and resource control module 430. In an embodiment, the data routing and resource control module 430 may be connected to the data bus 424 (where the bandwidth of the data bus 424 is sufficiently high, as described below). As illustrated in FIG. 4, the data routing and resource control module 430 is connected to the external interface controller 420 via an interface 432 (e.g., a dedicated data bus) and provides a direct interface between the external interface controllers 420 and the DAC audio driver(s) 402, the DMA controller 406, the screen graphics driver 410, and the storage interface driver 414. As such, certain data can be routed directly between the external interface controllers 420 and the DAC audio driver(s) 402, the DMA controller 406, the screen graphics driver 410, and the storage interface driver 414, bypassing both the CPU 422 and the data bus 424.

Thus, incoming communications related to the resource sharing described herein (e.g., control protocols and data) are received by the external interface controllers 420, sent to the data routing and resource control module 430 over the interface 432, and routed by the data routing and resource control module 430 to the appropriate one of the DAC audio driver(s) 402, the DMA controller 406, the screen graphics driver 410, and/or the storage interface driver 414. Data to be sent to the external device(s) is accessed by the data routing and resource control module 430 from the appropriate one of the DAC audio driver(s) 402, the DMA controller 406, the screen graphics driver 410, and/or the storage interface driver 414 and sent to the external interface controllers 420 for transmission to the external device(s).

For example, for the mobile device 400 to display data from an external device on the screen 412, the screen data is received at an external interface controller 420, passed to the data routing and resource control module 430, sent to the screen graphics driver 410, and displayed on the screen 412. As another example, for the mobile device 400 to send data stored in the non-volatile storage 416 to an external device, the data routing and resource control module 430 retrieves the data from the non-volatile storage 416 via the storage interface driver 414 and sends the retrieved data to the appropriate external interface controller 420 where it is transmitted to the external device(s).

As will be appreciated, bypassing the CPU 422 and the data bus 424 eliminates the bottleneck that can be created by the CPU 422 and the data bus 424 when sharing data between the mobile device 400 and an external device as described herein. The CPU 422 may, however, continue to process regular communications data received at the mobile device 400 and any synchronization operations (e.g., inter-operating setup and control operations) between the mobile device 400 and the external device(s) for the data/resource sharing described herein.

Note that in the embodiment illustrated in FIG. 4, any data exchanged between the CPU 422 and the DAC audio driver(s) 402, the DMA controller 406, the screen graphics driver 410, and the storage interface driver 414 would be routed through the data routing and resource control module 430. However, this is not required, and data may be exchanged between the CPU 422 and the DAC audio driver(s) 402, the DMA controller 406, the screen graphics driver 410, and the storage interface driver 414 without having to be intercepted and acted upon by the data routing and resource control module 430. For example, the data routing and resource control module 430 may be connected to the DAC audio driver(s) 402, the DMA controller 406, the screen graphics driver 410, the storage interface driver 414, and the external interface controllers 420 via a dedicated data bus different than the data bus 424 that connects the CPU 422 to the DAC audio driver(s) 402, the DMA controller 406, the screen graphics driver 410, the storage interface driver 414, and the external interface controllers 420. In this embodiment, the data routing and resource control module 430 may be connected to the CPU 422 by either this dedicated bus, the data bus 424, or yet another data bus.

In an aspect, the data routing and resource control module 430 may selectively bridge data between the CPU 422 and one or more of the DAC audio drivers 402, the DMA controller 406, the screen graphics driver 410, and the storage interface controller 414 according to the function(s) of the mobile device 400 being controlled by an external mobile device. More specifically, the data routing and resource control module 430 may access and operate on data from modules being controlled/utilized by an external mobile device (e.g., the screen graphics driver 410 and the DAC audio drivers 402) and may act as a bridge between the CPU 422 and the remaining modules (e.g., the DMA controller 406 and the storage interface driver 414). As will be appreciated, this may apply in whole or in part. That is, the data routing and resource control module 430 may serve as a data bridge between the CPU 422 and the DAC audio driver(s) 402, the DMA controller 406, the screen graphics driver 410, and the storage interface driver 414 when no other mobile device is connected to the mobile device 400, or as a data bridge between the CPU 422 and only those of the DAC audio driver(s) 402, the DMA controller 406, the screen graphics driver 410, and the storage interface driver 414 that are not being controlled/utilized by an external mobile device. Where the data routing and resource control module 430 acts as a bridge between the CPU 422 and the DAC audio driver(s) 402, the DMA controller 406, the screen graphics driver 410, and the storage interface driver 414, the CPU 422 controls the DAC audio driver(s) 402, the DMA controller 406, the screen graphics driver 410, and the storage interface driver 414 rather than the data routing and resource control module 430.

The data routing and resource control module 430 should have sufficient processing functionality to route data to the DAC audio driver(s) 402, the DMA controller 406, the screen graphics driver 410, and/or the storage interface driver 414 from the external interface controllers 420, and vice versa. Additionally, when connected to the CPU 422 by a separate data bus, the data routing and resource control module 430 should have sufficient processing functionality to route data to/from the CPU 422 via the external interface controllers 420.

In an embodiment, the data routing and resource control module 430 may be a hardware module (e.g., an integrated circuit (IC), a field-programmable gate array (FPGA), an application-specific integrated circuit (ASIC), etc.), such that the data routing and resource control module 430 exists at a lower level of the protocol stack of the mobile device 400, such as at the system/machine/hardware layer versus the operating system layer or software layer. By implementing the data routing and resource control module 430 at the machine layer, the additional resources of the connected mobile devices seamlessly appear to the operating system as additional internal resources (e.g., as a larger RAM, a larger non-volatile storage, more CPU cores, additional screens or screen space, etc.).

Referring back to the specific example illustrated in FIG. 2A, both mobile devices 202 and 204 may correspond to mobile device 400 in FIG. 4 and may serve a separate viewing and/or audio perspective for the same software application. As described above, in an embodiment, each mobile device 202 and 204 may have the software application installed, and each instance of the application may serve the separate viewing/audio perspectives for the software application. In this example, mobile devices 202 and 204 may exchange synchronization data 206 via an external interface controller 420 (corresponding to the type of wired or wireless connection between mobile devices 202 and 204). Since only synchronization data 206 is being exchanged, the synchronization data 206 may be transferred over the data bus 424 and processed by the CPU 422.

However, in the embodiment where only the mobile device 202 may have the software application installed, the mobile device 202 may transmit data needed to execute the software application on the mobile device 204 to the mobile device 204, or only the data needed to provide the separate viewing perspective or audio perspective of the software application on the mobile device 204. In this case, the data routing and resource control module 430 may retrieve the data needed to execute the software application on the mobile device 204 or the data needed to provide the separate viewing/audio perspectives of the software application on the mobile device 204 from the DAC audio driver(s) 402, the DMA controller 406, the screen graphics driver 410, and/or the storage interface driver 414, as appropriate. The data routing and resource control module 430 then transmits the retrieved data to the external interface controller 420 for transmission to the mobile device 204, bypassing the CPU 422 and the data bus 424. As in the first example, the mobile devices 202 and 204 may also exchange/process synchronization data 206 via the external interface controller 420, the data bus 424, and the CPU 422.

Referring to the specific example illustrated in FIG. 2B, as noted above, the mobile devices 202 and 204 may share one or more resources to permit a user to utilize the mobile devices 202 and 204 as a dual-screen work station. In this example, the data routing and resource control module 430 on each of the mobile devices 202 and 204 enables the RAM 408 and the non-volatile storage 416 of each mobile device 202 and 204 to effectively be combined. Specifically, the mobile devices 202 and 204 exchange synchronization data 206 (e.g., control protocols) via their respective external interface controllers 420 to enable the mobile devices 202 and 204 to view the RAM 408 and the non-volatile storage 416 of each mobile device 202 and 204 as a single RAM resource and non-volatile storage resource, respectively. The synchronization data 206 may also enable the screen 412 of each mobile device 202 and 204 to be shared by the other of the mobile devices 202 and 204, for example, as split screens, as duplicate screens, as extended screens, etc. In an embodiment, the data routing and resource control module 430 on each of the mobile devices 202 and 204 may enable the processing functionality of the CPU 422 of each mobile device 202 and 204 to effectively be combined. Because such synchronization data 206 consumes a minimal amount of bandwidth, the synchronization data 206 may be transferred over the data bus 424 and processed by the CPU 422.

Once synchronized, any data to be written to or read from the RAM 408 and/or the non-volatile storage 416 of the mobile devices 202 and 204 may be transferred to/from the RAM 408 and the non-volatile storage 416 via the external interface controller 420 and the data routing and resource control module 430 of the respective mobile device 202 or 204, bypassing the CPU 422 and the data bus 424 of each mobile device 202 and 204. Likewise, any screen sharing data is transmitted to/from the screen graphics driver 410 of the mobile devices 202 and 204 via the external interface controller 420 and data routing and resource control module 430 of the respective mobile device 202 or 204, also bypassing the CPU 422 and the data bus 424.

Where the data routing and resource control module 430 is connected to the CPU 422 by a data bus other than the data bus 424, any shared processing to be performed by the CPU 422 of each of mobile devices 202 and 204 may be affected by transmitting data to a CPU 422 via the external interface controller 420 and data routing and resource control module 430 of the respective mobile device 202 or 204, thereby bypassing the data bus 424. Alternatively, where the data bus 424 has sufficient bandwidth, the data routing and resource control module 430 may be connected to the CPU 422 via the data bus 424, and any shared processing to be performed by the CPU 422 may be affected by transmitting data to the CPU 422 via the external interface controller 420 and data routing and resource control module 430 of the respective mobile device 202 or 204 over the data bus 424.

Thus, the user may launch one or more software applications on one of the mobile devices 202 and 204, and the mobile devices 202 and 204 will setup the resource sharing functionality described herein so that the one or more software applications may be executed by both CPUs 422, data related to the one or more software applications may be stored in RAM 408 and/or non-volatile storage 416, and screens 412 may be combined as a single screen, split screens, extended screens, or the like.

For simplicity, one mobile device, such as the mobile device 202, may act as a master device, and the other mobile device, such as the mobile device 204, may act as a slave device. In this embodiment, any additional mobile devices may be operated as slave devices. As such, the mobile device 202 may initiate the synchronization of the mobile devices 202 and 204 and any data exchange between the mobile devices 202 and 204 to provide the resource sharing described herein.

Note, however, that the mobile device 204 may still operate autonomously. That is, the mobile device 204 may still be operated (by the user) as a standalone device, and not only as an extension of the mobile device 202. For example, while the mobile device 204 is acting as a slave device of the mobile device 202, the user may launch and interact with one or more applications other than the software applications being executed as part of the shared resource experience being directed by the mobile device 202.

Further, the mobile devices 202 and 204 do not have to be setup as a master device and a slave device. Instead, the user may operate each mobile device 202 and 204 autonomously, and depending on the functionality/application initiated on one mobile device, the mobile devices 202 and 204 may establish the resource sharing functionality described above. For example, the user may initiate a first software application on mobile device 202 and a second software application on mobile device 204. The mobile devices 202 and 204 may exchange synchronization data 206 related to the first and second software applications via the external interface controller 420, the data bus 424, and the CPU 422, and share data related to the first and second software applications via the external interface controller 420, the data routing and resource control module 430, and the respective one of the DAC audio driver(s) 402, the DMA controller 406, the screen graphics driver 410, the storage interface driver 414, and optionally the CPU 422 (where the mobile devices 202 and 204 are sharing processing power and the data routing and resource control module 430 is connected to the CPU 422 over a data bus other than the data bus 424).

In an embodiment, where multiple mobile devices, such as mobile devices 202 and 204, are sharing their non-volatile storage 416, the mobile devices, via the respective data routing and resource control modules 430, may implement the non-volatile storages 416 as a redundant array of independent discs (RAID) 0 to “stripe” data across the multiple non-volatile storages 416. In RAID 0, the same file is stored across the multiple non-volatile storages 416, permitting it to be read out and re-assembled from the multiple non-volatile storages 416 at the same time, thereby decreasing the time required to access the file. RAID 0 also provides a level of security. Specifically, each non-volatile storage 416 will only have a portion of the data needed to reconstruct the file. As such, the file cannot be reconstructed without all mobile devices interacting with each other.

An additional advantage of implementing RAID 0 is that the process of striping reduces the amount of data conveyed over the wired or wireless connection between the multiple mobile devices, thereby improving file read/write speed proportional to the reduced data conveyed over the adjoining connection between the mobile devices. Specifically, since a portion of the file is stored on each mobile device, only the remainder of the file needs to be transferred from one mobile device to the other.

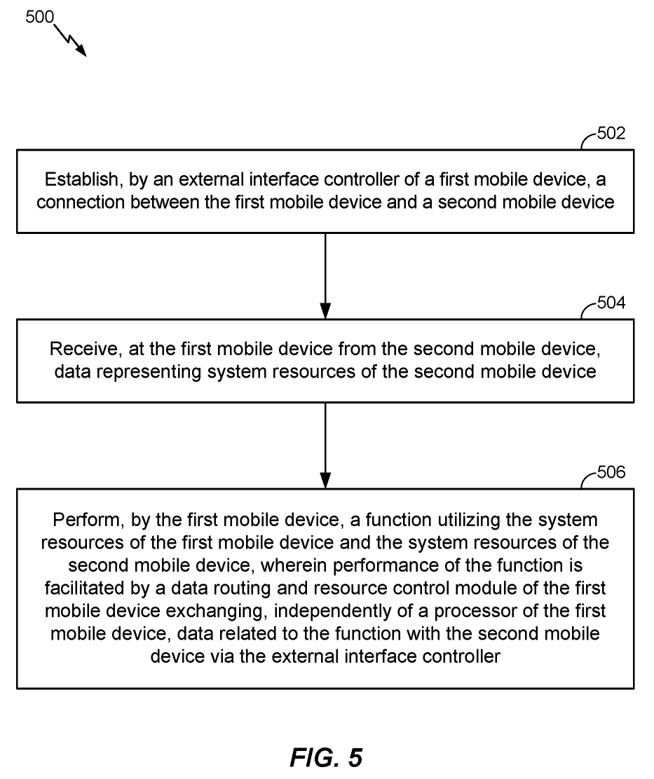

FIG. 5 illustrates an exemplary flow 500 for sharing system resources between a first mobile device (e.g., mobile device 202) and a second mobile device (e.g., mobile device 204) according to at least one aspect of the disclosure. As noted above, both the first mobile device 202 and the second mobile device 204 may correspond to mobile device 400.

At 502, an external interface controller (e.g., one of external interface controllers 420) of the first mobile device 202 establishes a connection between the first mobile device 202 and the second mobile device 204.

At 504, the first mobile device 202 (e.g., CPU 422 in conjunction with one of external interface controllers 420) receives, from the second mobile device 204, data representing system resources of the second mobile device 204.

At 506, the first mobile device 202 performs a function utilizing the system resources of the first mobile device 202 and the system resources of the second mobile device 204. Performance of the function may be facilitated by a data routing and resource control module (e.g., data routing and resource control module 430) of the first mobile device 202 exchanging, independently of a processor (e.g., CPU 422) of the first mobile device 202, data related to the function with the second mobile device 204 via the external interface controller.

In an aspect, the function may be a screen sharing function between the first mobile device 202 and the second mobile device 204, an audio sharing function between the first mobile device 202 and the second mobile device 204, execution of a software application on the first mobile device 202 and the second mobile device 204, storage of a file on the first mobile device 202 and the second mobile device 204, sharing of processing functionality of the first mobile device 202 and the second mobile device 204, or any combination thereof. In this case, execution of the software application may include presentation of a first viewing perspective of the software application on a display of the first mobile device 202 and a second viewing perspective of the software application on a display of the second mobile device 204. Storage of the file on the first mobile device 202 and the second mobile device 204 may include storage of a first portion of the file on the first mobile device 202 and a second portion of the file on the second mobile device 204. In an aspect, the data related to the function may be the first portion of the file.

In an aspect, the data routing and resource control module may exchange the data related to the function by sending, over an interface between the data routing and resource control module and the external interface controller (e.g., interface 432), the data related to the function to the external interface controller for transmission to the second mobile device 204. In this case, the processor may receive the data representing the system resources of the second mobile device 204 from the external interface controller over a common data bus (e.g., data bus 424) other than the interface between the data routing and resource control module and the external interface controller.

In an aspect, the data routing and resource control module may exchange the data related to the function by receiving, over an interface between the data routing and resource control module and the external interface controller (e.g., interface 432), the data related to the function from the external interface controller based on reception of the data related to the function from the second mobile device 204.

In an aspect, utilization of the system resources of the second mobile device 204 is transparent to an operating system of the first mobile device 202.

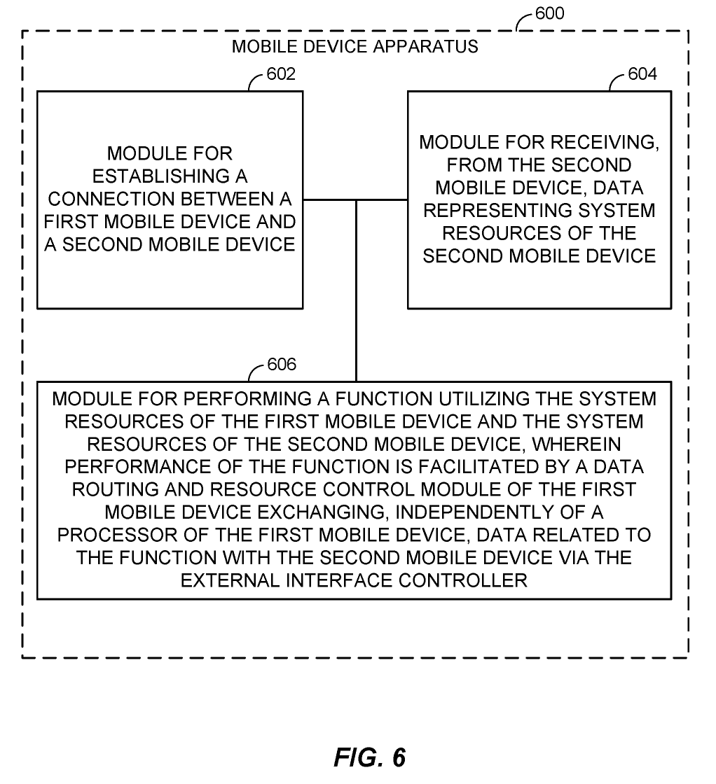

FIG. 6 illustrates an example mobile device apparatus 600 represented as a series of interrelated functional modules. A module for establishing 602 may correspond at least in some aspects to, for example, a communication device, such as one or more of external interface controllers 420, as discussed herein. A module for receiving 604 may correspond at least in some aspects to, for example, a communication device, such as one or more of external interface controllers 420, as discussed herein. A module for performing 606 may correspond at least in some aspects to, for example, a processing system in conjunction with a communication device, such as data routing and resource control module 430 in conjunction with one or more of external interface controllers 420, as discussed herein.

The functionality of the modules of FIG. 6 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 6, as well as other components and functions described herein, may be implemented using any suitable means. Such means also may be implemented, at least in part, using corresponding structure as taught herein. For example, the components described above in conjunction with the “module for” components of FIG. 6 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

What is claimed is:

1. A method for sharing system resources between a first mobile device and a second mobile device, comprising:
establishing, by an external interface controller of the first mobile device, a connection between the first mobile device and the second mobile device;
receiving, at the first mobile device from the second mobile device, data representing system resources of the second mobile device; and
performing, by the first mobile device, a function utilizing the system resources of the first mobile device and the system resources of the second mobile device,
wherein performance of the function is facilitated by a data routing and resource control module of the first mobile device exchanging, independently of a processor of the first mobile device, data related to the function with the second mobile device via the external interface controller.

2. The method of claim 1, wherein the data routing and resource control module exchanges the data related to the function by sending, over an interface between the data routing and resource control module and the external interface controller, the data related to the function to the external interface controller for transmission to the second mobile device.

3. The method of claim 2, wherein the processor receives the data representing the system resources of the second mobile device from the external interface controller over a common data bus other than the interface between the data routing and resource control module and the external interface controller.

4. The method of claim 1, wherein the data routing and resource control module exchanges the data related to the function by receiving, over an interface between the data routing and resource control module and the external interface controller, the data related to the function from the external interface controller based on reception of the data related to the function from the second mobile device.

5. The method of claim 1, wherein utilization of the system resources of the second mobile device is transparent to an operating system of the first mobile device.

6. The method of claim 1, wherein the function comprises a screen sharing function between the first mobile device and the second mobile device, an audio sharing function between the first mobile device and the second mobile device, execution of a software application on the first mobile device and the second mobile device, storage of a file on the first mobile device and the second mobile device, sharing of processing functionality of the first mobile device and the second mobile device, or any combination thereof.

7. The method of claim 6, wherein execution of the software application comprises presentation of a first viewing perspective of the software application on a display of the first mobile device and a second viewing perspective of the software application on a display of the second mobile device.

8. The method of claim 6, wherein storage of the file on the first mobile device and the second mobile device comprises storage of a first portion of the file on the first mobile device and a second portion of the file on the second mobile device.

9. The method of claim 8, wherein the data related to the function comprises the first portion of the file.

10. The method of claim 1, wherein the first mobile device and the second mobile device comprise tablet computers.

11. The method of claim 1, wherein the system resources of the second mobile device comprise a processor, volatile memory, non-volatile memory, screen, network connections, or any combination thereof.

12. The method of claim 1, wherein the data routing and resource control module is a hardware component of the first mobile device.

13. An apparatus for sharing system resources between a first mobile device and a second mobile device, comprising:
at least one processor;
an external interface controller configured to:
establish a connection between the first mobile device and the second mobile device; and
receive, from the second mobile device, data representing system resources of the second mobile device; and
a data routing and resource control module configured to facilitate performance of a function that utilizes the system resources of the first mobile device and the system resources of the second mobile device,
wherein the data routing and resource control module being configured to facilitate the performance of the function comprises the data routing and resource control module being configured to exchange, independently of the at least one processor, data related to the function with the second mobile device via the external interface controller.

14. The apparatus of claim 13, wherein the data routing and resource control module being configured to exchange the data related to the function comprises the data routing and resource control module being configured to send, over an interface between the data routing and resource control module and the external interface controller, the data related to the function to the external interface controller for transmission to the second mobile device.

15. The apparatus of claim 13, wherein the data routing and resource control module being configured to exchange the data related to the function comprises the data routing and resource control module being configured to receive, over an interface between the data routing and resource control module and the external interface controller, the data related to the function from the external interface controller based on reception of the data related to the function from the second mobile device.

16. The apparatus of claim 13, wherein the function comprises a screen sharing function between the first mobile device and the second mobile device, execution of a software application on the first mobile device and the second mobile device, storage of a file on the first mobile device and the second mobile device, sharing of processing functionality of the first mobile device and the second mobile device, or any combination thereof.

17. The apparatus of claim 16, wherein execution of the software application comprises presentation of a first viewing perspective of the software application on a display of the first mobile device and a second viewing perspective of the software application on a display of the second mobile device.

18. The apparatus of claim 16, wherein storage of the file on the first mobile device and the second mobile device comprises storage of a first portion of the file on the first mobile device and a second portion of the file on the second mobile device.

19. The apparatus of claim 13, wherein the data routing and resource control module is a hardware component of the first mobile device.

20. A non-transitory computer-readable medium for sharing system resources between a first mobile device and a second mobile device, comprising:
at least one instruction to cause an external interface controller of the first mobile device to establish a connection between the first mobile device and the second mobile device;
at least one instruction to cause the first mobile device to receive, from the second mobile device, data representing system resources of the second mobile device; and
at least one instruction to cause the first mobile device to perform a function utilizing the system resources of the first mobile device and the system resources of the second mobile device,
wherein performance of the function is facilitated by a data routing and resource control module of the first mobile device exchanging, independently of a processor of the first mobile device, data related to the function with the second mobile device via the external interface controller.
